(19) United States
(12) Patent Application Publication
(10) Pub. No.: US 2005/0127009 A1
(43) Pub. Date: Jun. 16, 2005

(54) Process for reducing contaminants in process water and/or condensate

(76) Inventor: Emmett R. Yawn, Mandeville, LA (US)

Correspondence Address: David L. Hedden;Ashland Inc., P.O. Box 2219, Columbus, OH, 43216, US

(21) Appl. No.: 10/949,695

(22) Filed: Sep. 24, 2004

Related U.S. Application Data
(60) Provisional application No. 60/509,980, filed on Oct. 9, 2003.

(51) Int. Cl. C02F 1/56

(52) U.S. Cl. 210/735; 210/723

(57) ABSTRACT

This invention relates to a process for reducing contaminants in contaminated process water and/or condensate.

### TECHNICAL FIELD OF THE INVENTION

This invention relates to a process for reducing the contaminants in contaminated process water and/or condensate.

### BACKGROUND OF THE INVENTION

There are many industrial process that use process water in carrying out reactions, as an effluent for removing unwanted by-products, as a diluent, and for many other functions. Examples of industrial processes, which use process water, include, for example, the refining of petroleum; the production of olefins, polymers, and organic acids; the production of metals, e.g. aluminum, iron, steel, and copper; and the benefaction of coal.

The process water often comes into contact with a variety of contaminants when the industrial process is carried out. These contaminants remain in the process water. Although there may be many contaminants in the process water and they vary depending upon the type of industrial process carried out, the more deleterious contaminants include suspended solids, oil and grease, metals, and silicate compounds.

The process water is often subject to elevated temperatures. It may be converted to steam, which often undergoes condensation. The condensate may also contain the contaminants that are present in the process water.

Although there are many methods known for removing contaminants from aqueous systems, these methods cannot be successfully used to remove contaminants from process water and condensates, particularly without reducing the heat capacity of the process water and/or condensate. Process water and/or condensate differs from other aqueous systems because the temperature of the process water and/or condensate is elevated, e.g. it typically ranges between 80° C. and 100° C. Because the temperature is elevated, it is difficult to purify condensate, particularly without reducing the heat capacity of the process water and/or condensate. Additionally, the difficulty is compounded because the process water and/or condensate may have high alkalinity, which increases the stability of the emulsion of oil found in the process water and/or condensate.

The elevated temperature and high alkalinity of the process water and/or condensate also impairs the usefulness of chemicals typically used to break the emulsion, and/or coagulate suspended solids. Thus, many processes that could be used to purify process water and/or condensate are not compatible with the high temperatures and alkalinity.

The temperature of process water and/or condensate typically ranges between 80° C. and 100° C. If the purification can be carried out without any reduction in the heat capacity of the process water and/or condensate, a great deal of energy can be conserved. The water does not have to be re-heated for use in the process or as boiler feedwater.

One example of process water and/or condensate, which has the potential for reuse, is that generated by the production of alumina from bauxite ore. The majority of aluminum produced today is manufactured from bauxite ore. One of the primary means for converting bauxite ore to alumina is by the Bayer process as shown in FIG. 1. The alumina is then converted to aluminum is produced commercially by the electrolytic smelting of alumina.

In order to produce alumina by the Bayer process, the bauxite ore is ground and then digested in hot concentrated caustic. From the digester, the liquor is concentrated through flashing of steam. The steam condensate carries impurities such as mineral oil, silica, iron oxide, and other suspended solids from the ore. Because the condensate also contains some of the caustic from the digestion process, the oil can be strongly emulsified.

The temperature of the process water and/or condensate is typically from 95°-100° C. Consequently, it has the potential to be used as a boiler feedwater if the impurities could be removed. However, if utilized without treatment, the boilers would exhibit frequent failures, which would result because of the precipitation of impurities. Because there is no effective and economical way of removing the impurities from the process water and/or condensate, the process water and/or condensate is frequently wasted.

All citations referred to in this application are expressly incorporated by reference.

### DESCRIPTION OF THE DRAWINGS

FIG. 1 is a diagram, which illustrates how the Bayer the Bayer process is typically carried out. The Bayer process is used to convert bauxite ore to alumina and identifies condensate streams used in the process. The process generates process water and condensate containing contaminants.

### BRIEF SUMMARY OF THE INVENTION

This invention relates to a process for reducing contaminants in contaminated process water and/or condensate, wherein said process comprises the steps of:
(a) adding from 1 ppm to 1,000 ppm, preferably from 5 ppm to 200 ppm, and most preferably from 10 to 100 ppm of a first coagulant having a mean volume average of from 1 micron to about 25 microns, preferably from about 5 microns to about 15 microns to the process water and/or condensate to be purified;
(b) then adding from 1 ppm to 1,000 ppm, preferably from 5 ppm to 200 ppm, and most preferably from 10 to 100 ppm of a second coagulant having a mean volume average of from 40 microns to about 200 microns, preferably from about 50 microns to about 100 microns;
(c) filtering said process water and/or condensate.

Although the process can be used to remove impurities from other process water and/or condensate, it has been shown that the process is particularly useful for removing impurities from process water and condensate, which is generated by the production of alumina from bauxite ore. After the process water and/or condensate has been purified, it can then be recycled through the process used to convert bauxite to alumina, or it can be used as boiler feedwater.

The process is particularly useful, because impurities can be removed from the process water and/or condensate without any substantial reduction in the heat capacity of the process water and/or condensate. The heat capacity in some cases exceeds one million BTU's per 1,000 gallons of process water and/or condensate.

The process is carried out on-line with negligible heat loss. The time it takes for the contaminated water to enter the treatment and leave the treatment process is approximately 30 to 90 seconds.

### DETAILED DESCRIPTION OF THE INVENTION

The detailed description and examples will illustrate specific embodiments of the invention will enable one skilled in the art to practice the invention, including the best mode. It is contemplated that many equivalent embodiments of the invention will be operable besides these specifically disclosed.

The function of the first coagulant is to break any oil-water emulsion (oil includes grease) existing in the process water and/or condensate to be treated. The first coagulant separates the oil and the process water and/or condensate, so the oil can be coagulated with the solids in the next step of the process. The pH of the condensate at this stage of the process is typically between 8.5 and 10.0.

The first coagulant has a colloid structure, preferably symmetrical, and has a mean volume average of from about 1 micron to about 25 microns, preferably from about 5 microns to about 15 microns. Examples of the coagulants that can be used as the first coagulant include cationic electrolytes with a low molecular weight. Most preferably used as the first coagulant are melamine formaldehyde cationic coagulants, particularly those having a melamine to formaldehyde ratio of about 1:1 to about 1:10, preferably from about 1:2 to about 2:8.

The function of the second coagulant is to agglomerate the oil and suspended solids in the process water and/or condensate, so that the suspended solids can be effectively removed from the process water and/or condensate by filtration. The pH of the condensate at this stage of the process is also typically between 8.5 and 10.0.

The second coagulant has a colloid structure, preferably asymmetrical, and has a mean volume average of from about 40 microns to about 200 microns, preferably from about 50 microns to about 100 microns. Methods of preparing such coagulants are described in U.S. Pat. No. 4,558,080; 4,734,216; and 4,781,839. Preferably, the tannin-based coagulant is prepared with condensed polyphenolic tannins under slightly acidic conditions, where the pH is less than 7, and where the molar ratio of the primary amine from the amino compound to the tannin repeating unit is from about 1.5:1 to about 3.0:1.

The second coagulant is added within minutes, typically within 60 seconds after the first coagulant is added to the process water and/or condensate to be treated. Typically, it is added close to the inlet of the filter, and it is used to pre-coat the filter media.

Although a variety of filters are useful for carrying out the filtration step of the process, the preferred filter is a fluidized bed filter, particularly an upflow sand filter. This filter utilizes a fluidized bed where the media in the fluidized bed develops a negative charge. This allows the cationic coagulants to pre-coat the filter, which causes the contaminants to stick to the media. This enables one to use less coagulant and the coagulant is removed from the stream, preventing it from becoming an impurity in the filtered fluid.

Particularly useful, as the filter, is the DynaSand® filter supplied by Parkson Corporation. This filter is a continuous-backwash, upflow, deep-bed, granular-media filter. Recycling the sand internally through an airlift pipe and sand washer continuously cleans the filter media. The cleansed sand is redistributed on top of the sand bed, allowing for continuous flow of filtration and rejected water. Other features of the filter include a continuously cleaned sand bed, no moving parts, low pressure drop, high solids capability, and a top-feed design.

In some instances it may be useful to heat the process water and/or condensate before the cationic coagulant is added to the process water and/or condensate.

As was pointed out previously, the subject process is particularly useful for treating process water and/or condensate generated by the Bayer process used to produce alumina from bauxite. In the Bayer process, process water and/or condensate is generated as follows:
1. The flash steam that is produced from pressure reduction of the digester effluent is used to heat the feed to the digester. The flash steam is ultimately condensed and is the largest source of process condensate that is produced.
2. Further downstream in the process, solids are removed for disposal and the clear supernate (containing caustic and dissolved alumina) is precipitated in a series of multiple effect evaporators. These evaporators produce the second largest stream of process condensate.

Note that both these streams are generated by the process rather than from condensed steam from the powerhouse. This is why they are so contaminated.
3. Other sources of condensate are the condensed steam from the surface condensers and steam heated process vessels.

After the contaminated water and/or condensate is treated, it can be piped (the motive pressure of the steam may be sufficient to transport it) or pumped, if necessary, to the boiler feedwater unit, recycled in the process, or sent to a holding tank where is stored until it is ready to be used.

Abbreviations and/or Definitions

MFC a melamine formaldehyde cationic coagulant having melamine to formaldehyde mole ratio 2:8 having a mean volume average of from about 10 microns.
TAC tannin amine coagulant having, supplied by ECOLAB under the tradename WCS 4110, having a having a mean volume average of from about 50 to 100 microns.
FILTER a fluidized bed sand filter supplied by Parkson Corporation under the trademark DynaSand® sand filter.

### EXAMPLES

While the invention has been described with reference to a preferred embodiment, those skilled in the art will understand that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. In this application all units are in the metric system and all amounts and percentages are by weight, unless otherwise expressly indicated.

### Example

### (Clarification of Condensate Generated by the Bayer Process for Producing Alumina)

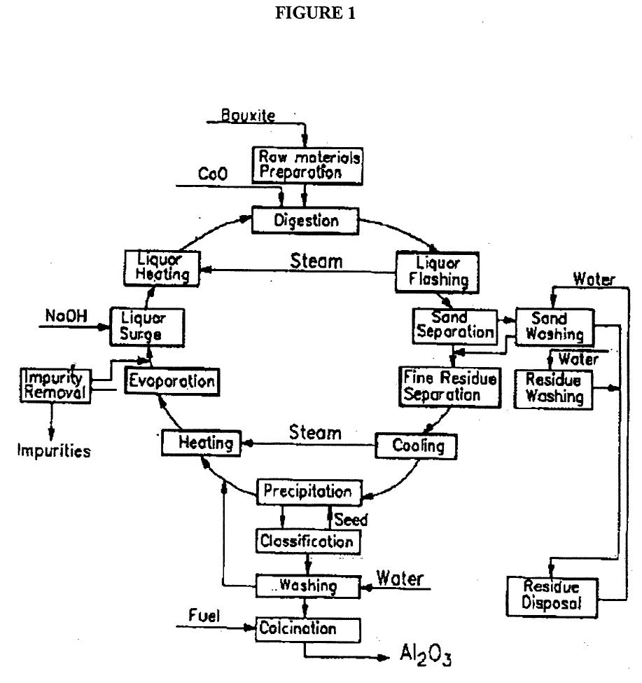

This example illustrates how the process is used to remove contaminants from the digester process water (DPW) and the evaporator process condensate (EPC), generated by the Bayer process for producing alumina. The alumina was produced from bauxite by the Bayer process as shown FIG. 1. The temperature of the DPW was from about 80° C. to about 100° C. and the temperature of the EPC was from about 80° C. to about 100° C. The flow rate for the condensate tested was approximately 60 GPM and tests were conducted for about a month. The sample was piped from the process and the purification took place done on-line.

Twenty ppm of MFC were added to samples of the DPW and the EPC. Ten seconds later, 15 ppm of TAC were added to the DPW and the EPC, which had been treated with the melamine formaldehyde emulsion breaker. The condensate was then filtered using FILTER.

The contaminants (CNT) in the condensate, and their amounts before (DPWB and EPWB) and after treatment (DPWA and EPWA) are set forth in Table I for the two different streams, the digester stream and evaporator stream, along with the change (CH) and percent change (% CH). The most important contaminants in this process are total suspended solids (TSS), oil and grease (O&G), iron (FE), and barium (BA).

There was no significant loss of heat from the contaminated process water during the treatment process, and the time it took for the contaminated water to enter the treatment and leave the treatment process was approximately one minute.

Table I
(Impurities before and after treatment)

| CNT | UNITS | DPWB | DPWA | CH | % CH | EPWB | EPWA | CH | % CH |
|---|---|---|---|---|---|---|---|---|---|
| TSS | mg/l | 6.4 | 0 | 6.4 | 100 | 2.7 | 0 | 2.7 | 100 |
| O&G | mg/l | 69.1 | 3.3 | 65.8 | 95.2 | 4.7 | 2.2 | 2.5 | 53.19 |
| FE | ppm | 2.7 | 0.05 | 2.65 | 98.15 | 0.10 | 0 | 0.10 | 100 |
| BA | ppm | 0.7 | 0.07 | 0.63 | 90.0 | 0.30 | 0 | 0.30 | 100 |

The results in Table I clearly demonstrate the effectiveness of the treatment process. The amounts of several different contaminants were substantially reduced or removed when the process condensate was treated according to the process. The purified water can then be used as boiler feedwater or recycled as process water.

1. A process for reducing the contaminants in contaminated process water and/or condensate, wherein said process comprises the steps of:
(a) adding from 1 ppm to 1,000 ppm of a first coagulant having a having a mean volume average of from about 1 micron to about 25 microns to the process water and/or condensate to be treated;
(b) then adding from 1 ppm to 1,000 ppm of a second coagulant having a mean volume average of from about 40 microns to about 200 microns;
(c) filtering said process water and/or condensate.

2. The process of claim 1 wherein the temperature of the treated process water and/or condensate is from 80° C. to 100° C.

3. The process of claim 2 wherein the emulsion breaker is a cationic melamine formaldehyde coagulant.

4. The process of claim 3 wherein the coagulant is a mannich-tannin coagulant.

5. The process of claim 4 wherein the filter used for filtering is an upflow sand filter.

6. The process of claim 5 wherein the process water and/or condensate is generated from the production of alumina from bauxite ore.

7. The process of claim 6 wherein the process used to prepare the alumina from bauxite ore is the Bayer process.

8. The process of claim 7 wherein the purified process water and/or condensate is recycled in the Bayer process for converting bauxite ore to alumina.

9. The process of claim 1, 2, 3, 4, 5, 6, 7, or 8 wherein the purified process water and/or condensate is used as boiler feedwater.
